(19) United States
(12) Patent Application Publication
(10) Pub. No.: US 2026/0186941 A1
(43) Pub. Date: Jul. 2, 2026

(54) PREFETCHING AND CACHING BETWEEN HIGH BANDWIDTH MEMORY (HBM) AND NON-VOLATILE (NVM) CACHE ON PROCESSING DIE

(71) Applicant: Micron Technology, Inc., Boise, ID (US)

(72) Inventors: Xiangyu Tang, San Jose, CA (US); Eric N. Lee, San Jose, CA (US); Jeffrey S. McNeil, Boise, ID (US); Akira Goda, Tokyo (JP); Suresh Rajgopal, San Diego, CA (US); Sundararajan Sankaranarayanan, Fremont, CA (US)

(21) Appl. No.: 19/434,431

(22) Filed: Dec. 29, 2025

Related U.S. Application Data
(60) Provisional application No. 63/740,397, filed on Dec. 31, 2024.
(60) Provisional application No. 63/740,399, filed on Dec. 31, 2024.
(60) Provisional application No. 63/764,725, filed on Feb. 28, 2025.

(51) Int. Cl. G06F 11/34; G06F 9/30

(52) U.S. Cl. CPC G06F 11/3442; G06F 9/30047; G06F 11/3452

(57) ABSTRACT

A compute device includes a compute die, a on-chip cache with one or more volatile memory dies and one or more non-volatile memory dies, and a memory controller all disposed on the package substrate. The controller separates read commands, received from the compute die, according to processing threads executed by the compute die and includes prediction engines and coupled performance monitors. A first prediction engine predicts, for a first processing thread, a first data access pattern associated with a first read command received from the first processing thread. A first performance monitor determines a first statistical value corresponding to a likelihood that the first prediction engine successfully predicted the first data access pattern. The first performance monitor, responsive to the first statistical value satisfying a threshold value, forwards a prefetch command consistent with the first data access pattern to a prefetch command manager for handling.

### CLAIM OF PRIORTY

The present application claims the benefit under 35 U.S.C. § 119(e) of U.S. Provisional Ser. No. 63/764,725 filed Feb. 28, 2025, U.S. Provisional Ser. No. 63/740,397 , filed Dec. 31, 2024 and U.S. Provisional Ser. No. 63/740,399, filed Dec. 31, 2024, all of which are incorporated by reference herein.

### TECHNICAL FIELD

Implementations of the disclosure relate generally to compute devices, and more specifically, relate to address prefetching and caching between HBM and NVM cache on a processing die.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various implementations of the disclosure.

FIG. 1 is an example system employing a compute device having a hybrid on-chip cache (e.g., with combined volatile memory (VM) and NVM dies) on a processing die according to some embodiments.

FIG. 2 is an example prefetch and cache controller of the memory controller of the compute device of FIG. 1 according to some embodiments.

FIG. 3A is a flow chart of an example method for performing prefetch of data from the hybrid on-chip cache on behalf of a compute device on the processing die according to some embodiments.

FIG. 3B is a flow chart of an example method for executing a prefetch command manager to schedule, with priorities, prefetch commands in view of host commands and memory management commands according to at least one embodiment.

FIG. 4 is a flow chart of an example method for controlling caching of prefetched data from the method of FIG. 3A according to some embodiments.

FIGS. 5A-5B show example high-level component diagrams of hybrid NVM/HBM devices implemented in accordance with aspects of the present disclosure.

FIG. 6 schematically illustrates example logical and physical address spaces of the hybrid NVM/HBM devices implemented in accordance with aspects of the present disclosure.

FIG. 7 illustrates an example computing system that includes a memory sub-system implemented in accordance with some implementations of the present disclosure.

FIG. 8 is a block diagram illustrating a system for performing AI model inference operations using memory devices and/or host systems implemented in accordance with aspects of the present disclosure.

FIG. 9 is a block diagram of an example computer system in which implementations of the present disclosure may operate.

### DETAILED DESCRIPTION

Aspects of the present disclosure are directed to prefetching and caching between a hybrid on-chip cache (that includes HBM and NVM dies) and a compute die of a compute device, which can be designed on a common substrate package. A memory sub-system can include one or more storage devices, memory modules, and/or hybrid storage devices and memory modules. Examples of storage devices and memory modules are described below. In general, a host system can utilize a memory sub-system that includes one or more components, such as memory devices that store data. The host system can provide data to be stored at the memory sub-system and can request data to be retrieved from the memory sub-system.

A memory sub-system may utilize one or more memory devices, including any combination of the different types of non-volatile memory devices and/or volatile memory devices, to store the data provided by the host system. In some implementations, non-volatile memory devices may be provided by negative-and (NAND) type flash memory devices. A non-volatile memory device is a package of one or more dies. Each die (“logical unit”) may include one or more planes. For some types of non-volatile memory devices (e.g., NAND devices), each plane may include a set of physical blocks. Each block may in turn include a set of pages. Each page includes a set of memory cells. A memory cell is an electronic circuit that stores one or more bits of information.

A memory device may include multiple memory cells arranged in a two-dimensional grid. The memory cells can be formed onto a silicon wafer in an array of columns and rows. A memory cell includes a capacitor that holds an electric charge and a transistor that acts as a switch controlling access to the capacitor. Accordingly, the memory cell may be programmed (written to) by applying a certain voltage, which results in an electric charge being held by the capacitor. The memory cells are joined by wordlines, which are conducting lines electrically connected to the control gates of the memory cells, and bitlines, which are conducting lines electrically connected to the drain electrodes of the memory cells.

Depending on the cell type, each memory cell may store one or more bits of information and has various logic states that correlate to the number of bits being stored. The logic states may be represented by binary values, such as “0” and “1”, or combinations of such values. A memory cell may be programmed (written to) by applying a certain voltage to the memory cell, which results in an electric charge being held by the memory cell, thus allowing modulation of the voltage distributions produced by the memory cell. A set of memory cells referred to as a memory page may be programmed together in a single operation, e.g., by selecting consecutive bitlines.

Precisely controlling the amount of the electric charge stored by the memory cell allows establishing multiple logical levels, thus effectively allowing a single memory cell to store multiple bits of information. A read operation may be performed by comparing the measured threshold voltages (Vt) exhibited by the memory cell to one or more reference voltage levels in order to distinguish between two logical levels for single-level cell (SLCs) and between multiple logical levels for multi-level cells. Each logical level may be translated into a corresponding binary representation of the content of the memory cell.

Memory access operations (e.g., a read operation, a programming (write) operation, an erase operation, etc.) may be executed with respect to sets of the memory cells, e.g., in response to receiving memory access commands from the host. A memory access operation may specify the requested memory access operation (e.g., write, erase, read, etc.) and a logical address, which the memory sub-system would translate to a physical address identifying a set of memory cells (e.g., a block).

In some implementations, memory sub-systems can be used to store data used to train machine learning (ML) and artificial intelligence (AI) frameworks, as well as data on which the ML/AI framework can be executed. An ML/AI framework can include a model, which is a representation of a neural network designed to produce one or more outputs responsive to one or more inputs. In such frameworks, the amount of data used to train the ML models can be extremely large and a training process cycle can be executed multiple times (e.g., multiple “epochs”). For example, an ML framework used to classify an image as being a particular type of image (e.g., an image of a person, an animal, a type of animal, etc.) can utilize a large data set of stored images that are repeatedly processed in multiple epoch cycles to train the model. Similarly, data sets used for testing and/or inference stages of a ML/AI workflow can include very large amounts of data. For example, the inference stage utilizes the trained model, which is very large and requires significant storage, to make predictions or decisions on new input data. This process can include processing the input data, feeding it into the model, and post-processing the output of the model if necessary.

In order to process the large amounts of data, many host systems executing ML/AI frameworks include multiple processing units or compute devices (e.g., graphics processing units (GPUs) and/or central processing units (CPU)) which can process multiple threads/streams in parallel. During the inference phase, these processing units utilize relatively small chunks of data (e.g., tens or hundreds of bytes) from a significantly larger corpus of data (e.g., many gigabytes or terabytes) stored at a memory sub-system. For example, the inference phase may involve walking through multiple graph nodes in order to determine the value of a vertex element and identify its connections.

In some implementations, the input data can be loaded from the memory sub-system to a local host memory co-located with the processing units executing the ML/AI framework. This host memory can be implemented using high bandwidth memory (HBM) devices that offer extremely high (i.e., fast) performance, but have relatively low storage capacities.

In some implementations, multiple processing units or compute devices (GPUs and/or CPUs) can be connected to a shared memory pool, such that each processing unit can have its own local memory and can also access, over a high-speed interconnect, the memory that is local to other processing units. However, the local memory accesses would exhibit much lower latency as compared to the remote memory accesses.

Thus, the memory capacity is one of the biggest challenges faced by enterprise deployment of AI/ML models. Various solutions involve increasing the number of dies stacked in HBM packages accessible by a processing unit or compute device (e.g., a GPU) and implementing various non-uniform memory access (NUMA) schemes in which a processing unit, in addition to its local memory, may also access a local memory of another processing unit. However, these and other solutions fail to adequately satisfy the growing memory capacity requirements while delivering the requisite memory access bandwidth and latency, not to mention containing the costs.

Aspects of the present disclosure address the above and other deficiencies by integrating non-volatile memory (NVM) dies (e.g., NAND) with volatile memory (VM) dies (e.g., HBM dies) as on-chip cache within a single hybrid compute device, e.g., an integrated circuit (IC) on a common package substrate of a GPU or CPU. Thus, in some embodiments, the hybrid compute device is or includes a processing unit such as a GPU or CPU, thus affording increased memory capacity on the same package as a compute die, reducing the need for off-package data movement operations between the memory dies because the VM/NVM dies are locally accessible by the compute die. Further, by storing the most-frequently accessed data in the VM or HBM dies, a higher number of hits at the faster memory can be realized due to more predictable, repetitive compute operations performed in AI/ML frameworks. In the case of a miss at the HBM dies, on-chip memory control can be configured to retrieve the data from the NVM dies and store the data in the HBM dies. In this way, the VM or HBM dies can operate as a type of first-level cache while the NVM dies can operate as a second-level cache, both on-die of the compute device and operating transparently to the compute die.

In illustrative embodiments, the hybrid compute device includes, in addition to the compute die, one or more one NVM dies, one or more HBM dies, and a logic die on which a local memory controller can reside. The local memory controller can perform the address translation and other local memory management tasks, which will be discussed in more detail. In some embodiments, the hybrid compute device includes one or more compute dies on which one or more processing units (GPUs and/or CPUs) reside. Further, the local memory controller can perform prefetch and caching operations that detect data access patterns that often exist in AI/ML (or similar) architectures. High levels of successfully predicting the subsequent data items to be prefetched and, if necessary, stored in the HBM dies (if not already there) can ensure a high bandwidth and low latency of data access at the hybrid on-chip cache despite having much of the data stored in high-capacity but slower NVM dies.

These and other advantages of the approaches described herein include the improved performance of memory devices and subsystems, which may be particularly beneficial when used in ML/AI frameworks, and will be described in more detail herein below. For example, AI/ML training and inference phases can be iterative over time, thus performing similar compute operations on the same or similar data across time. In some embodiments, training a ML model generally involves forward propagation of inputs, followed by backward propagation (adjusting weights to minimize error), followed by updating weights in memory, and ultimately by generating outputs. Thus, data accessed for each of these operations or phases is more predictable, if known. In this way, by receiving or detecting hints from the compute die related to which AI/ML phase is being performed, a prefetch prediction engine can more accurately predict a data access pattern and accurately prefetch the correct data to be accessed next.

In at least some embodiments, a compute die is disposed on a package substrate. A on-chip cache is disposed on the package substrate and coupled to the compute die. In embodiments, the on-chip cache includes one or more volatile memory dies (e.g., HBM or other dynamic random access memory (DRAM) dies) and one or more non-volatile memory dies. A memory controller, disposed on the package substrate, can be coupled between the compute die and the on-chip cache. The memory controller can separate read commands, received from the compute die, according to a plurality of processing threads executed by the compute die.

In such embodiments, the memory controller includes multiple prediction engines, each to process a separate processing thread since prefetching data associated with an individual processing thread is expected to be more accurate. Each prediction engine can thus predict a data access pattern for each respective processing thread. The memory controller can include multiple performance monitors, each coupled to an output of one of the prediction engines. Each performance monitor can generate statistical value corresponding to a likelihood that the coupled prediction engine successfully predicted the data access pattern, e.g., based on past performance in terms of both hits rates at the on-chip cache and ultimate use of prefetched data by the compute die. If the first statistical value satisfies a threshold value, the performance monitor can forward a prefetch command consistent with the first data access pattern to a prefetch command manager for handling. If, however, the first statistical value does not satisfy the threshold value, the performance monitor can drop or trash the prefetch command, which is thus not forwarded to the prefetch command manager for handling.

In some implementations, one or more hybrid compute devices implemented in accordance with one or more aspects of the present disclosure may be packaged into a specified form factor, e.g., a form factor utilized by non-volatile memory devices, a form factor utilized by storage devices (such as solid state drives (SSDs)), or the like. Using a standard memory form factor would facilitate seamless integration of the device into various computing systems, such as, e.g., Internet-of-Things (IoT) devices, wearable or portable computing devices, automotive computing devices, enterprise compute systems, or enterprise storage systems, etc.

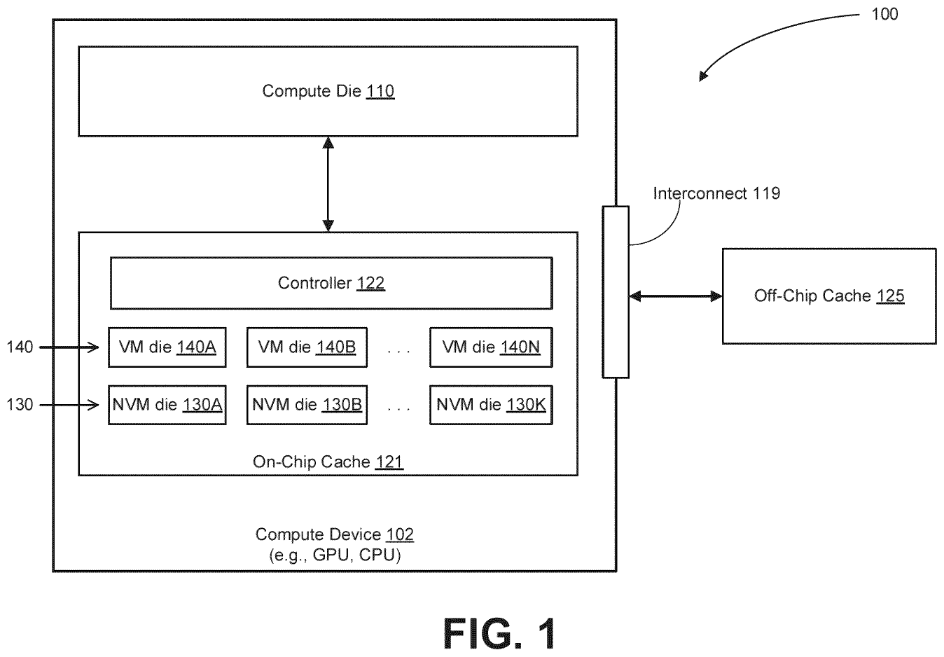

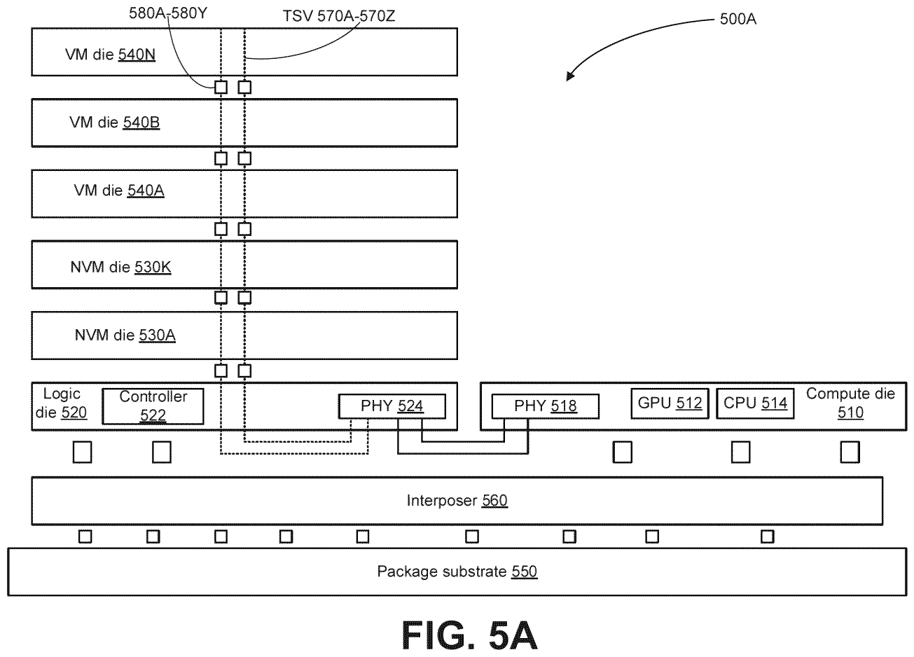

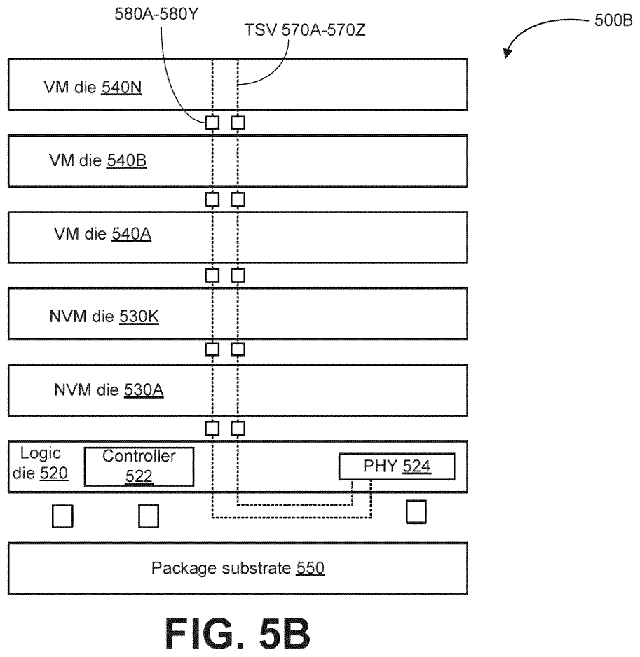

FIG. 1 is an example system 100 employing a compute device 102 having a hybrid on-chip cache 121 (e.g., combined VM and NVM dies) on a processing die according to some embodiments. The compute device 102 can include memory and compute components disposed on a common package substrate (see FIGS. 5A-5B). The system 100 can further include an interconnect 119 disposed on the package substrate and coupled to a off-chip cache 125 that is disposed off of the package substrate. In an embodiment, the interconnect 119 is a Peripheral Component Interconnect Express (PCIe) or other high-speed interface that connects components of a printed circuit board, e.g., like graphics cards, hard drives, and network adapters.

In some embodiments, the compute device 102 includes a compute die 110 disposed on the package substrate and the on-chip cache 121 disposed on the package substrate and coupled to the compute die 110. In embodiments, the on-chip cache 121 includes one or more volatile memory dies (e.g., VM dies 140, which can operate as a first-level cache) and one or more non-volatile memory dies (e.g., NVM dies 130, which can operate as a second-level cache). For example, the VM dies 140 can include a first VM die 140A, a second VM die 140B, through to an Nth VM die 140N, which can be DRAM, but for higher speed modern compute devices, may be HBM dies. Further, the NVM dies 130 can include a first NVM die 130A, a second NVM die 130B, through to a Kth NVM die 130K, which can be, for example, NAND dies or flash-based memory dies.

In some embodiments, the compute device 102 includes a memory controller 122, disposed on the package substrate, and coupled between the compute die 110 and the on-chip cache 121. Thus, the memory controller 122 can be located as part of the on-chip cache 121 or as stand-alone processing logic on a logic die (see FIGS. 5A-5B). In at least some embodiments, the memory controller 122 is configured to make management of the on-chip cache 121 transparent to the compute die 110.

For example, the memory controller 122 can make the combination of the VM dies 140 and the NVM dies 130 appear as uniform cache and manage address translations, compensation for delay between access speeds of VM dies compared to NVM dies, and other media management associated with the on-chip cache 121. The memory controller 122 can balance data-storing workloads across the VM dies 140 and the NVM dies 130, manage the NVM dies 130 for garbage collection and data integrity, and conduct caching and prefetching operations as between the VM dies 140 and the NVM dies 130, the latter of which will be described in more detail. In embodiments of balancing data storage, the data stored in the NVM dies 130 can be preemptively copied to the NVM dies 140 for faster access according a loading scheme and following various caching algorithms, which will be discussed.

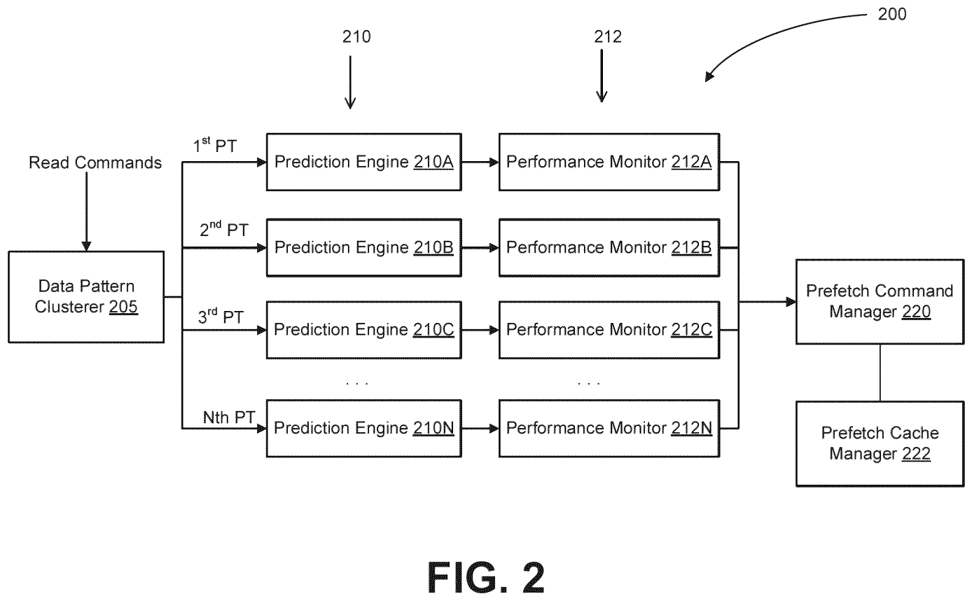

FIG. 2 is an example prefetch and cache controller 200 of the memory controller 122 of the compute device 102 of FIG. 1 according to some embodiments. That is, the prefetch and cache controller 200 can be integrated as a part of the hardware and/or firmware of the controller 122 discussed with reference to FIG. 1. In some embodiments, the controller 200 includes a data pattern clusterer 205 configured to separate read commands, received from the compute die 110, according to a plurality of processing threads executed by the compute die 110. For example, in some embodiments, the compute die 110 includes a plurality of processing cores, each executing one of the plurality of processing threads, which is common in modern-day GPUs. In other embodiments, more common in CPUs, the compute die 110 supports simultaneous multithreading (SMT), known as hyper-threading (HT) in some processors, time-sliced multitasking, also known as context switching, or vectorization, also referred to as single instruction, multiple data (SIMD) processing, or other types of multi-process computing.

The data pattern clusterer 105 can identify the processing threads within a stream of read commands by detecting a thread identifier associated with each read command. Alternatively, or additionally, the data pattern clusterer 105 can determine that logical addresses or physical addresses of the read commands have spatial locality, e.g., are located near each other in the on-chip cache 121. Alternatively, or additionally, the data pattern clusterer 105 can determine that accesses of data at the physical addresses have temporal locality, e.g., are being accessed close in time. By identifying separate processing threads and separating them so prediction can be performed on each processing thread individually, memory accesses can be isolated based on individual thread activity, which is more often successfully predictable. For example, different activities produce different access patterns that lend to better prefetch predictions, as will be discussed.

In some embodiments, the controller 200 further includes multiple prediction engines 210A, each to process a separate processing thread since prefetching data associated with an individual processing thread is expected to be more accurate, as discussed. For example, the multiple prediction engines 210A can include a first prediction engine 210A assigned to a first processing thread, a second prediction engine 210B assigned to a second processing thread, a third prediction engine 210C assigned to a third processing thread, and an Nth prediction engine 210N assigned to an Nth processing thread, with additional possible prediction engines therebetween to handle additional processing threads. Each prediction engine 210 can thus predict a data access pattern associated with a particular processing thread as read commands are identified as being associated with that particular processing thread. Having a prediction engine work on just one processing thread at a time can improve prediction accuracy and reduce prediction engine complexity.

Predicting each data access pattern, by a given prediction engine, can be performed based on accessing certain data and information. For example, the prediction engine can analyze changes in data addresses between sequentially received read commands, changes in access times between the sequentially received read commands, or statistical calculations such as a mean, a median, a probabilistic model, or a combination thereof in the changes in data addresses or the changes in access times. Probabilistic models can include Fourier Transform, Wavelet Transform, Kalman filters and particle filters, Markov chains, and/or Principal Component Analysis (PCA). The prediction engine can also perform an application of weights to the statistical calculations based on recency of data used for determining the statistical calculations and/or detect patterns using a pattern recognition algorithm.

In varying embodiments, the pattern recognition algorithms include machine learning (e.g., tree-based models, liner models, instance-based methods, Bayesian models), deep learning and neural networks (such as convolutional neural networks, recurrent neural networks, transformer models, autoencoders, or generative adversarial networks), statistical and probabilistic methods (some of which were already discussed), and/or specialized algorithms for specific pattern detection (such as Haar Cascades for face detection, You Only Look Once (YOLO) for object detection, Hough Transform for geometric shape detection, edge detection (Canny, Sobel, Prewitt) to identify boundaries, and/or Optical Flow (Lucas-Kanade, Farneback) to detect motion patterns in video sequences.

In some embodiments, the controller 200 includes multiple performance monitors 212, each coupled to an output of one of the prediction engines 210. For example, the multiple performance monitors 212 can include a first performance monitor 212A to receive a prediction engine from the first prediction engine 210A, a second performance monitor 212B to receive a prediction from the second prediction engine 210B, a third performance monitor 212C to receive a prediction from the third prediction engine 210C, and an Nth performance monitor to receive a prediction from the Nth prediction engine 212N.

In such embodiments, each performance monitor 212 generates a statistical value corresponding to a likelihood that the coupled prediction engine successfully predicted the data access pattern. In at least some embodiments, the performance monitor 212 generates the statistical value based on past performance in terms of both hits rates at the on-chip cache and ultimate use of prefetched data by the compute die. For example, in embodiments, the performance monitor 212 determines historical successful hit rates by the coupled prediction engine or determines a percentage of previous prefetch commands, generated by the prediction engine, was for data ultimately used by the compute die 110, which is indicative of read amplification rates.

In some embodiments, if the statistical value satisfies a threshold value, the performance monitor 212 can forward a prefetch command consistent with the first data access pattern to a prefetch command manager 220 for handling. If, however, the first statistical value does not satisfy the threshold value, the performance monitor 212 can drop or trash the prefetch command, which is thus not forwarded to the prefetch command manager 220 for handling. By filtering out low-quality predictions from the prediction engines 210, the performance monitors 212 reduce prediction miss read overhead in the NVM dies 130 (and/or in a further memory device coupled externally to the compute device 102) and reduces overall read amplification. For example, in some embodiments, a hit rate combined with a read amplification rate can be combined into the statistical value used to determine whether to conduct prefetch. If the hit rate is too low and read amplification is too high, the statistical value would trigger the performance monitor 212 to drop or ignore the prefetch command.

In embodiments, the prefetch command manager 220 schedules prefetch commands among the other commands issued to the NVM dies 130 such as host read/write commands from the compute die 110, NAND management read/write commands, and other prefetch commands. In scheduling, the prefetch command manager 220 can give real-time read/write commands from the compute die 110 the highest priority, followed by prefetch/cache commands, followed by NAND management commands, which are given the lowest priority except when these commands become critical for data integrity, then the NAND management commands can be the highest priority.

In some embodiments, the controller 200 includes a prefetch cache manager 222 to manage prefetching data from the NVM dies 130 and/or an external memory device to fulfill a prefetch command, e.g., ensuring that data corresponding to an address in the prefetch command is stored (e.g., cached) in the VM dies 140. In managing caching, the prefetch cache manager 222 can execute cache algorithms that determine how to evict data from the VM dies 140, e.g., that are predicted to be accessed fewer times and further away (in spatial locality) in the future. Data that is evicted, which has been updated while being stored in the VM dies 140, can be flushed (e.g., updated) to the corresponding memory locations in the NVM dies 130. The prefetch cache manager 222 can analyze past data access patterns and determine whether associated data items will be accessed in the future, and, if so, how often and when. Data items that will be accessed soon and/or frequently can be maintained in the VM dies 140.

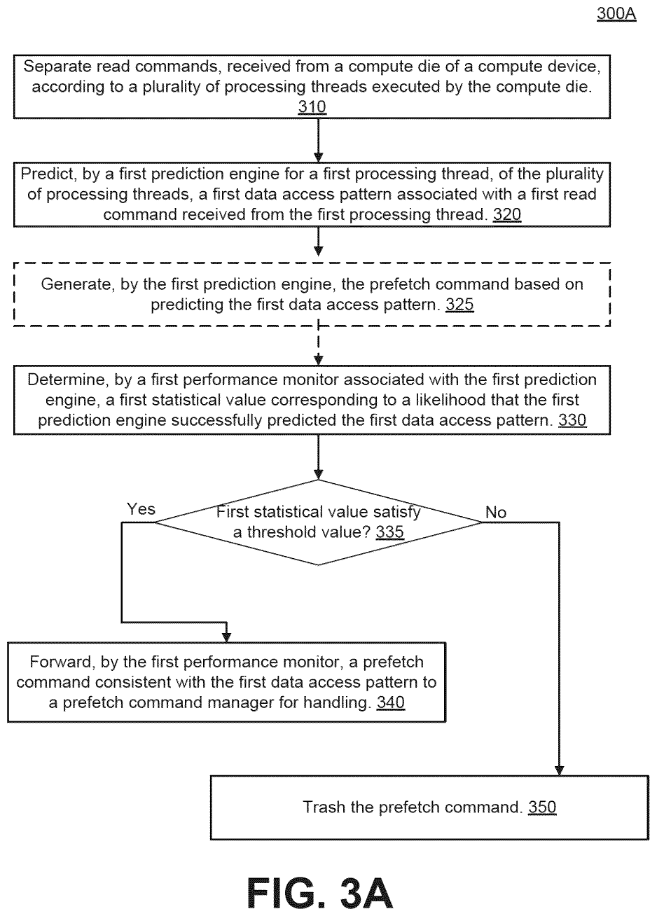

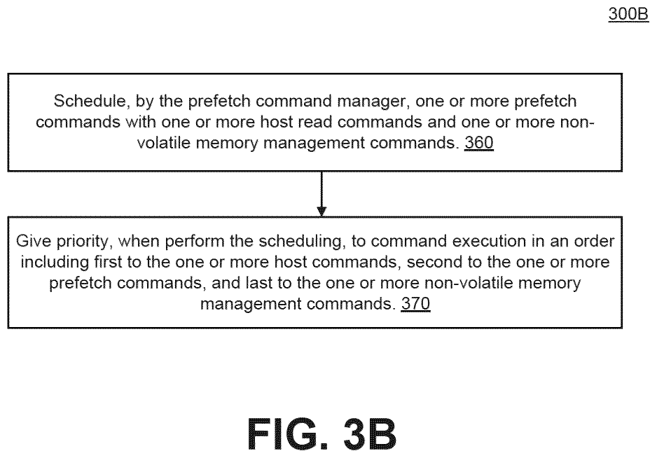

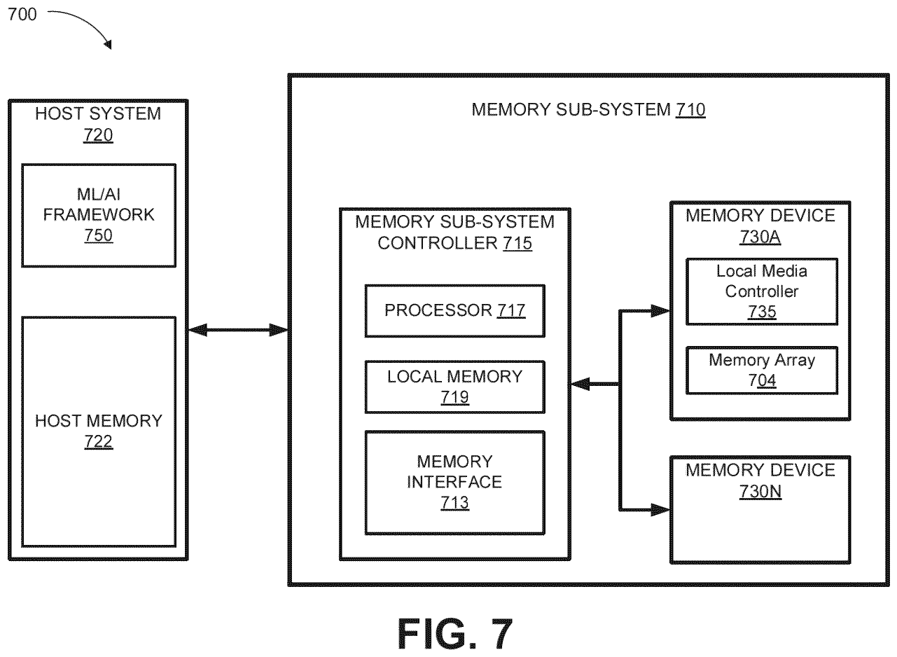

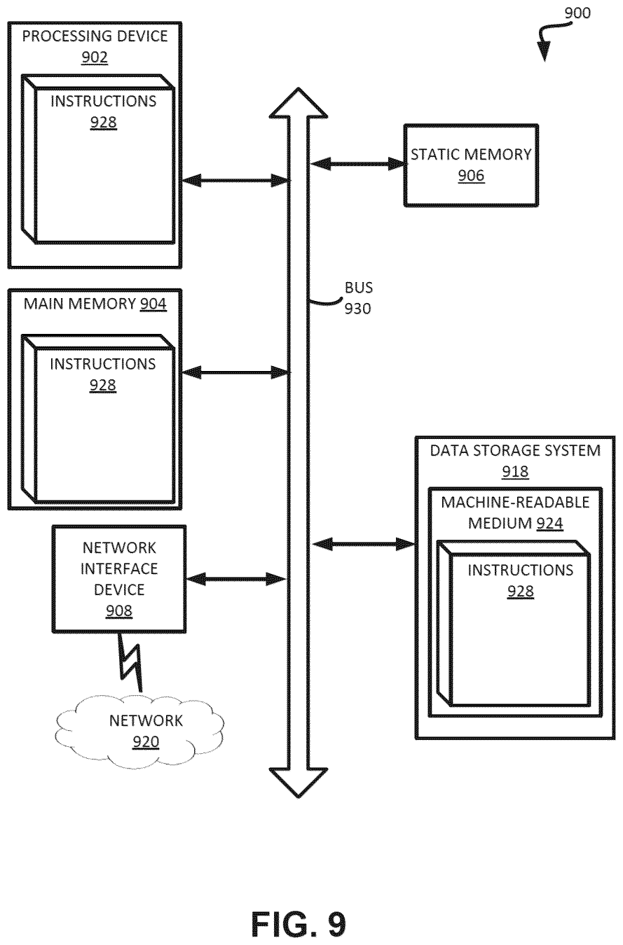

FIG. 3A is a flow chart of an example method 300A for performing prefetch of data from the hybrid on-chip cache on behalf of a compute device on the processing die according to some embodiments. The method 300A may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an illustrative example, the method 300A is performed by the controller 122 of FIG. 1 and/or the controller 200 of FIG. 2. In another illustrative example, the method 300A is performed by the memory sub-system controller 715 of FIG. 7. In another illustrative example, the method 300A is performed by the processing device 902 of FIG. 9. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 310, the processing logic separates read commands, received from the compute die 110, according to a plurality of processing threads executed by the compute die. The particulars of such separating of processing threads were discussed with reference to the data pattern clusterer 205 of FIG. 2.

At operation 320, the processing logic (e.g., the first prediction engine 210A for a first processing thread of the plurality of processing threads) predicts a first data access pattern associated with a first read command received from the first processing thread. For example, the first data access pattern can be in relation to the on-chip cache 121.

At operation 325, the processing logic (e.g., the first prediction engine) generates the prefetch command based on predicting the first data access pattern.

At operation 330, the processing logic (e.g., the first performance monitor 212A associated with the first prediction engine 210A) determines a first statistical value corresponding to a likelihood that the first prediction engine successfully predicted the first data access pattern.

At operation 335, the processing logic (e.g., the first performance monitor 212A) determines whether the first statistical value satisfies a threshold value, e.g., meets or exceeds that threshold value.

At operation 340, if the first statistical value satisfies the threshold value, the processing logic (e.g., the first performance monitor 212A) forwards a prefetch command consistent with the first data access pattern to the prefetch command manager 220 for handling. In embodiments, forwarding the prefetch command is from the first prediction engine 210A to the prefetch command manager 220.

At operation 350, if the first statistical value does not satisfy the threshold value, the processing logic (e.g., the first performance monitor 212A) drops or trashes the prefetch command so that the prefetch command is not forwarded to the prefetch command manager 220.

In some embodiments, the operations of the method 300A are repeated for each processing thread and for a stream of read commands. For example, in embodiments, the processing logic (e.g., a second prediction engine for a second processing thread, of the plurality of processing threads) predicts a second data access pattern associated with a second read command received from the second processing thread. The processing logic (e.g., a second performance monitor associated with the second prediction engine) determines a second statistical value associated with a likelihood of successfully predicting the second data access pattern. Responsive to the second statistical value satisfying the threshold value, the processing logic (e.g., the second performance monitor) transmits, a second prefetch command consistent with the second data access pattern to the prefetch command manager for handling.

FIG. 3B is a flow chart of an example method 300B for executing a prefetch command manager to schedule, with priorities, prefetch commands in view of host commands and memory management commands according to at least one embodiment. The method 300B may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an illustrative example, the method 300B is performed by the controller 122 of FIG. 1 and/or the controller 200 of FIG. 2. In another illustrative example, the method 300B is performed by the memory sub-system controller 715 of FIG. 7. In another illustrative example, the method 300B is performed by the processing device 902 of FIG. 9. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 360, the processing logic (e.g., the prefetch command manager 220) schedules one or more prefetch commands with one or more host read commands and one or more non-volatile memory management commands.

At operation 370, the processing logic (e.g., the prefetch command manager 220) gives priority, when performing the scheduling, to command execution in an order including first to the one or more host commands, second to the one or more prefetch commands, and last to the one or more non-volatile memory management commands.

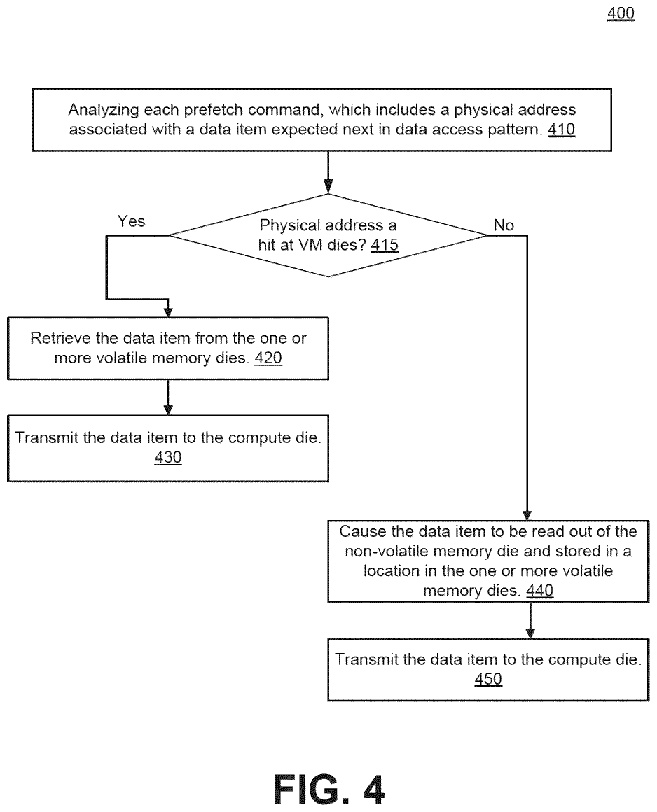

FIG. 4 is a flow chart of an example method 400 for controlling caching of prefetched data from the method of FIG. 3A according to some embodiments. The method 400 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an illustrative example, the method 400 is performed by the controller 122 of FIG. 1 and/or the controller 200 of FIG. 2. In another illustrative example, the method 400 is performed by the memory sub-system controller 715 of FIG. 7. In another illustrative example, the method 400 is performed by the processing device 902 of FIG. 9. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 410, the processing logic (e.g., the prefetch cache manager 222) analyzes each prefetch command, which includes a physical address associated with a data item expected next in the data access pattern.

At operation 415, the processing logic (e.g., the prefetch cache manager 222) determines whether the physical address is a hit at the VM dies 140.

If yes at operation 415, the physical address is a hit, at operation 420, the processing logic retrieves the data item from the one or more volatile memory dies. At operation 430, the processing logic transmits the data item to the compute die for handling.

If no at operation 415, the physical address is a miss, at operation 440, the processing logic causes the data item to be read out of the non-volatile memory die and stored in a location in the one or more volatile memory dies. At operation 450, the processing logic nonetheless still transmits the data item to the compute die.

FIG. 5A shows an example high-level component diagram of a hybrid NVM/HBM device implemented in accordance with aspects of the present disclosure. As schematically illustrated by FIG. 5A, the hybrid memory and compute device 500A may be implemented as an integrated circuit (IC) that includes a compute die 510, a logic die 520, one or more NVM dies 530A-530K, and one or more volatile memory (VM) dies 540A-540N, all the dies being disposed on a common package substrate 550.

Disposed on the compute die 510 are one or more processing units (e.g., one or more GPUs 512 and/or one or more CPUs 514) and their respective auxiliary circuitry, including local memory, input/output (I/O) interfaces, etc., which are omitted from FIG. 5A for clarity and conciseness. While a single compute die 510 is shown in FIG. 5A for clarity and conciseness, in various other implementations, device 500A may include two or more compute dies 510.

In some implementations, an NVM die 530 may be represented by a NAND die. In some implementations, one or more NVM dies 530 may be single-level cell (SLC) NAND dies, which exhibit better endurance and lower access latency as compared, e.g., to multiple-level cell (MLC), triple-level cell (TLC), or quad-level cell (QLC) dies. In some implementations, a VM die 540 may be represented by an HBM dynamic random access memory (DRAM) die.

While a single logic die 520 is shown in FIG. 5A for clarity and conciseness, in various other implementations, device 500A may include two or more logic dies 520.

The stacked VM dies 540, NVM dies 530, and the logic die 520 may be interconnected by through-silicon vias (TSVs) 570A-570Z and microbumps 580A-580Y. A TSV is a high-performance interconnect technique that utilizes a vertical electrical connection (via) that passes through a silicon wafer or die. “Microbumps” are small raised spheres which are made of a conductive material and connect a die with another die or a substrate, thus serving as conduits delivering electrical signals from one part of a chip to another.

The components disposed on the compute die 510 may communicate with the components disposed on the logic die 520, components disposed on the NVM dies 530A-530K, and/or components disposed on the VM dies 540A-540N via respective physical interfaces (PHYs) 518, 524 interconnected by the interposer 560. An interposer is an electrical interface routing electrical signals between one socket or connection and another socket or connection. Thus, the memory access requests issued by the processing units residing on the compute die 510 may be transmitted via the interposer 560 to the logic die 520.

Disposed on the logic die 520 is the controller 522 managing the NVM dies 530 and/or the VM dies 540. In some implementations, the controller 522 may implement a common logical address space for the VM dies 540A-540N and the NVM dies 530A-530K. Accordingly, the controller 522 may perform logical-to-physical (L2P) address translation based on the common logical address space.

In some implementations, no address translation (other than offsetting by a predefined value) may be required for the logical addresses that are below the upper limit of the user-addressable capacity of the VM dies 540A-540N. In other words, the logical addresses within the user-addressable capacity of the VM dies 540A-540N will directly (e.g., with an optional offset) reference respective memory locations on the VM dies 540A-540N, while the logical addresses exceeding the upper limit of the user-addressable capacity of the VM dies 540A-540N:

if LBA <= NVM Capacity then PA_{VM} = LBA + Offset
else PA_{NVM} = L2P[LBA]

where LBA is the logical block address,
NVM Capacity is he user-addressable capacity of the VM dies 540A-540N,
PA_{VM} is the physical address of a transfer unit (TU) residing on the VM dies 540A-540N,
Offset is the optional offset to be applied to the logical addresses,
PA_{NVM} is the physical address of a TU residing on the VM dies 530A-530K,
L2P[. . . ] is the logical-to-physical (L2P) address translation table, and
L2P[LBA] is the physical address corresponding to the specified LBA.

In an illustrative example, the total user-addressable capacity of the VM dies 540A-540N may be 40 GB, while the total user-addressable capacity of the NVM dies 530A-530K may be 128 GB. Thus, the memory access requests initiated by the compute die 510 with respect to transfer units (TUs) (such as memory pages, blocks, etc.) referenced by logical addresses below the upper limit of the user-addressable capacity of the VM dies 540A-540N may be satisfied directly via the physical interfaces 518 and 524 accessing the VM dies 540A-540N.

Conversely, memory access requests initiated by the compute die 510 with respect to TUs referenced by the logical addresses exceeding the upper limit of the user-addressable capacity of the VM dies 540A-540N may be sent to the controller 522, which may translate these logical addresses to corresponding physical addresses of TUs residing on the NVM dies 530A-530K. The address translation may be facilitated by a logical-to-physical (L2P) table, which may be indexed by the logical addresses so that each entry of the table would store a physical address corresponding to the logical address identifying the entry:
PA_{NVM}=L2P[LBA].

FIG. 5B shows another example high-level component diagram of a hybrid NVM/HBM device 500B implemented in accordance with aspects of the present disclosure. As schematically illustrated by FIG. 5B, the hybrid memory device 500B may be implemented as an integrated circuit (IC) that includes a logic die 520, one or more NVM dies 530A-530K, and one or more volatile memory (VM) dies 540A-540N, all the dies being disposed on a common package substrate 550. While a single logic die 520 is shown in FIG. 5B for clarity and conciseness, in various other implementations, device 500B may include two or more logic dies 520. The stacked VM dies 540, NVM dies 530, and the logic die 520 may be interconnected by through-silicon vias (TSVs) 570A-570Z and microbumps 580A-580Y.

Disposed on the logic die 520 is the controller 522 managing the NVM dies 530 and/or the VM dies 540. In some implementations, the controller 522 may implement a common logical address space for the VM dies 540A-540N and the NVM dies 530A-530K. Accordingly, the controller 522 may perform logical-to-physical (L2P) address translation based on the common logical address space, as described in more detail herein above.

The host system (not shown in FIG. 5B) may communicate with the components disposed on the logic die 520, components disposed on the NVM dies 530A-530K, and/or components disposed on the VM dies 540A-540N via the host interface 524. In some implementations, the host interface 524 may be represented by a logical host interface (e.g., NVMe) operating over a physical host interface (e.g., PCIe, CXL, SATA Express, etc.).

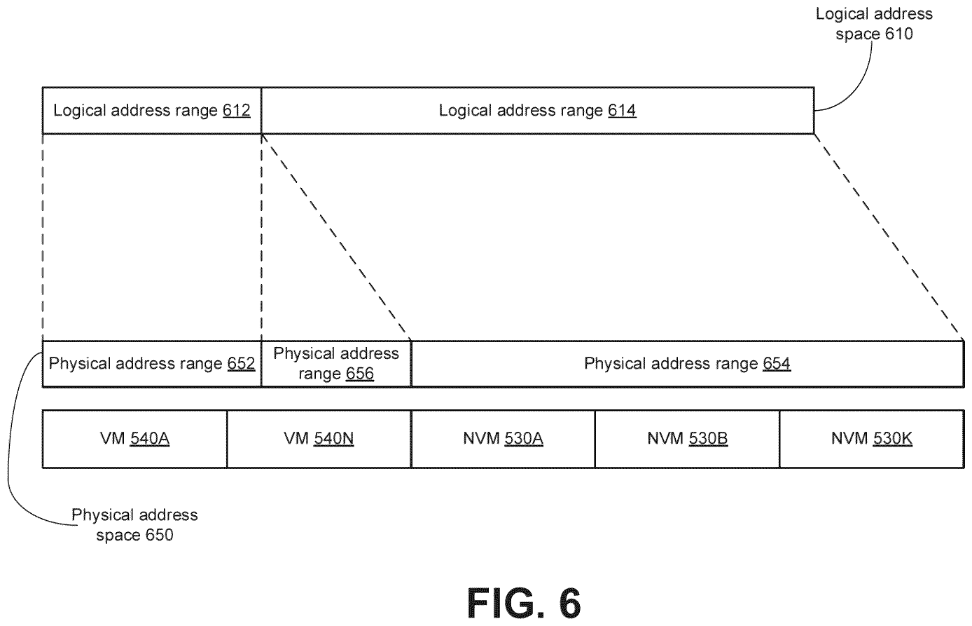

FIG. 6 schematically illustrates the example logical address space 610 and physical address space 650 of the device 500A-510B in accordance with aspects of the present disclosure. As schematically illustrated by FIG. 6, the logical address space 610 includes two logical address ranges 612 and 614.

The logical address range 612, the size of which matches the size of the user-addressable capacity of the VM dies 540A-540N, contains logical addresses that directly (e.g., with an optional offset) reference respective memory locations residing within the VM physical address range 652 corresponding to the user-addressable capacity of the VM dies 540A-540N.

The logical address range 614, residing immediately above the logical address range 612, contains logical addresses that are translatable to corresponding physical addresses identifying TUs that reside within the NVM physical address range 654 on the NVM dies 530A-530K. In some embodiments, the discussion with reference to FIG. 6 is applicable to the VM dies 140 and the NVM dies 130 of FIG. 1, where although both can be treated as on-chip cache, the VM dies 140 are faster-access cache and the NVM dies 130 are slower-access cache, and thus designed to back up the faster-access cache.

In some implementations, one or more physical address sub-ranges within the physical address ranges 652 and/or 654 may be reserved by the controller 522 for performing, e.g., various memory management and/or other system tasks. Accordingly, the size of the physical address range 652 and the size of the corresponding logical address range 612 may be less than the combined capacity of the VM dies 540A-540N. Similarly, the size of the physical address range 654 and the size of the corresponding logical address range 614 may be less than the combined capacity of the NVM dies 530A-530K.

In some implementations, content of the NVM dies 530A-530K may not be directly accessible by the processing units 512, 514 or the compute die 110 (FIG. 1). In an illustrative example, the controller 522 may reserve the capacity of the VM dies 540A-540N (or 140A-140N in FIG. 1) as fast-access cache to store certain portions (e.g., most recently accessed portions or most frequently accessed portions) of the slower-access content of the NVM dies 530A-530K (or 130A-130K of FIG. 1), although both may still be treated as the on-chip cache 121.

In operation, responsive to receiving a memory read request specifying a logical memory address to be read, the memory interface implemented by the logic die 520 may determine whether the logical memory address specified by the memory read request falls within the VM physical address range 652 corresponding to the fast-access capacity of the VM dies 540A-540N.

If the logical memory address specified by the memory read request falls within the VM physical address range 652, the memory interface implemented by the logic die 520 may read, from a volatile memory die 540A-540N, the data item stored in the location identified by the logical memory address. In some embodiments, the data item is returned to the requestor (e.g., a processing unit 512, 514 or the compute die 110) via the memory interface (e.g., the physical interfaces 518, 524).

Conversely, if the logical memory address specified by the memory read request falls outside the VM physical address range 652 and/or 656, the controller 522 may translate the logical address to a corresponding physical address within the physical address range 654 and/or 656. The controller 522 may then read the data stored at the TU (e.g., a block or a page) referenced by the physical address and return the data to the requestor (e.g., a processing unit 512, 514) via the memory interface (e.g., the physical interfaces 518, 524).

The controller 522 may determine whether the contents of the TU identified by the physical address had previously been cached in the VM dies 540A-540N (or 140A-140N of FIG. 1 of the fist-level cache 121). Should a hit occur, the read request may be satisfied from the VM dies. The contents of the identified cache line may be returned to the requestor (e.g., a processing unit 512, 514 or compute die 110) via a volatile memory interface (e.g., including the physical interfaces 518 and/or 524). In case of a miss, the controller 522 may allocate a new cache entry in the VM dies 540A-540N, read the contents of the TU identified by the physical address, store the retrieved data item in the newly allocated cache entry, and return the data item to the requestor processing unit 512, 514 via the volatile memory interface.

With additional reference to FIG. 1, in some embodiments, the on-chip cache 121 may implement the write-through policy. Accordingly, responsive to subsequently receiving a memory write request, the controller 122 or 522 may identify the cache entry whose tag matches the physical address corresponding to the logical address specified by the request. The controller 122 or 522 may store the data item specified by the memory request to the identified cache entry. The controller 122 or 522 may then store the content of the cache entry to the TU identified by the physical address. In various use cases, the compute device 102 or the IC 500 may be employed for both training and inference stages of AI models, such as large language models (LLMs), generative transformer models, etc.

In an illustrative example, the hybrid memory and the compute die 110, or hybrid memory and the compute device 500A, and/or the hybrid memory device 500B may be utilized for training of an artificial intelligence (AI) model. In another illustrative example, the compute device 102 and/or the hybrid memory devices 500A-500B may be utilized for implementing an inference stage of an artificial intelligence (AI) model.

In an illustrative example, training an AI model involves the need of storing and frequently accessing or modifying large amounts of data, including model states, weights, parameters, etc. This need can be effectively addressed by the compute device 102, the hybrid memory and compute device 500A, and/or the hybrid memory device 500B, which significantly increases the size of the local memory co-located with one or more processing units or the compute die 110.

In another illustrative example, performing an inference by an AI model involves handling a very large size of the model context, which requires the memory capacity that may exceed that of currently available solutions. This requirement is effectively met by the compute device 102, the hybrid memory and compute device 500A, and/or the hybrid memory device 500B, which can significantly increase the size of the local memory co-located with one or more processing units or the compute die 110.

FIG. 7 illustrates a high-level component diagram of an example computing system 700 that includes a memory sub-system 710 in accordance with some implementations of the present disclosure. The memory sub-system 710 can include one or more memory devices 730A-730N, which may include one or more volatile memory devices, and/or one or more non-volatile memory devices. In an illustrative example, one or more memory devices 730 may be represented by the compute device 102 or hybrid NVM/HBM devices 500A and/or 500B.

The memory sub-system 710 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 700 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 700 can include a host system 720 that is coupled to one or more memory sub-systems 730. In some implementations, the host system 720 is coupled to different types of memory sub-system 710. FIG. 7 illustrates one example of a host system 720 coupled to one memory sub-system 710. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 720 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 720 uses the memory sub-system 710, for example, to write data to the memory sub-system 710 and read data from the memory sub-system 710.

The host system 720 can be coupled to the memory sub-system 710 via a physical host interface. Examples of physical host interfaces include a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 720 and the memory sub-system 710. The host system 720 can further utilize an NVM Express (NVMe) interface to access the memory components (e.g., the one or more memory device(s) 730) when the memory sub-system 710 is coupled with the host system 720 by the physical host interface (e.g., PCIe or CXL bus). The physical host interface can provide an interface for passing control, address, data, and other signals between the memory sub-system 710 and the host system 720. FIG. 7 illustrates a memory sub-system 710 as an example. In general, the host system 720 can access multiple memory sub-systems via a same communication connection, multiple separate communication connections, and/or a combination of communication connections.

The memory devices 730A-730N can include any combination of the different types of non-volatile memory devices and/or volatile memory devices. In an illustrative example, one or more memory devices 730 may be represented by the compute device 102 or by the hybrid NVM/HBM devices 500A and/or 500B.

The volatile memory devices can be, e.g., random access memory (RAM), such as dynamic random access memory (DRAM) and synchronous dynamic random access memory (SDRAM). Some examples of non-volatile memory devices include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

A memory device 730A-730N can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some implementations, each of the memory devices 730 can include one or more arrays of memory cells such as SLCs, MLCs, TLCs, QLCs, or any combination of such. In some implementations, a particular memory device can include an SLC portion, and an MLC portion, a TLC portion, or a QLC portion of memory cells. The memory cells of the memory devices 730A-730N can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory devices 730A-730N can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 715 can communicate with the memory device(s) 730 to perform operations such as reading data, writing data, or erasing data at the memory devices 730 and other such operations. The memory sub-system controller 715 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 715 can be a microcontroller, special purpose logic circuitry (e.g., a field programmable gate array (FPGA), an application specific integrated circuit (ASIC), etc.), or other suitable processor.

The memory sub-system controller 715 can include a processor 717 (e.g., a processing device) configured to execute instructions stored in a local memory 719. In the illustrated example, the local memory 719 of the memory sub-system controller 715 includes an embedded memory configured to store instructions for performing various processes, operations, logic flows, and routines that control operation of the memory sub-system 710, including handling communications between the memory sub-system 710 and the host system 720.

In some implementations, the local memory 719 can include memory registers storing memory pointers, fetched data, etc. The local memory 719 can also include read-only memory (ROM) for storing micro-code. While the example memory sub-system 710 in FIG. 7 has been illustrated as including the memory sub-system controller 715, in another implementation of the present disclosure, a memory sub-system 710 does not include a memory sub-system controller 715, and can instead rely upon external control (e.g., provided by an external host, or by a processor or controller separate from the memory sub-system).

In general, the memory sub-system controller 715 can receive commands or operations from the host system 720 and can convert the commands or operations into instructions or appropriate commands to achieve the desired access to the memory device(s) 730. The memory sub-system controller 715 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 730. The memory sub-system controller 715 can further include host interface circuitry to communicate with the host system 720 via the physical host interface. The host interface circuitry can convert the commands received from the host system into command instructions to access the memory device(s) 730 as well as convert responses associated with the memory device(s) 730 into information for the host system 720.

The memory sub-system 710 can also include additional circuitry or components that are not illustrated. In some implementations, the memory sub-system 710 can include a cache or buffer (e.g., DRAM) and address circuitry (e.g., a row decoder and a column decoder) that can receive an address from the memory sub-system controller 715 and decode the address to access the memory device(s) 730.

In some implementations, the memory device(s) 730 include local media controllers 735 that operate in conjunction with memory sub-system controller 715 to execute operations on one or more memory cells of the memory device(s) 730. An external controller (e.g., memory sub-system controller 715) can externally manage the memory device 730 (e.g., perform media management operations on the memory device(s) 730). In some implementations, a memory device 730 is a managed memory device, which is a raw memory device (e.g., memory array 304) having control logic (e.g., local controller 735) for media management within the same memory device package. An example of a managed memory device is a managed NAND (MNAND) device. Memory device(s) 730, for example, can each represent a single die having some control logic (e.g., local media controller 735) embodied thereon. In some implementations, the local media controller 735 may be represented by the controller 122 of FIG. 1 or the controller 522 of FIGS. 5A-5B.

In some implementations, the memory sub-system 710 includes a memory interface 713 that is responsible for handling interactions of memory sub-system controller 715 with the memory devices of memory sub-system 710, such as memory devices 730A-730N. For example, the memory interface 713 can send or transmit memory access commands corresponding to requests received from host system 720 to memory devices 730A-730N, such as program commands, read commands, or other commands. In addition, the memory interface 713 can receive data from devices 730A-730N, such as data retrieved in response to a read command or a confirmation that a program command was successfully performed. In some implementations, the memory sub-system controller 715 includes at least a portion of the memory interface 713. For example, the memory sub-system controller 715 can include a processor 717 (processing device) configured to execute instructions stored in local memory 719 for performing the operations described herein.

In some implementations, the host system 720 implements an ML/AI framework 750. ML/AI framework 750 can include one or more ML models, a processing engine, and a training engine, among other components, which can be used to perform any automated task (e.g., classify or categorize documents or images). In order to train the one or more ML models, ML/AI framework 750 can issue requests to read the training data, which may be stored on one or more memory devices 730A-730N, and process the training data accordingly. In some implementations, ML/AI framework 750 is executed by multiple processing units (e.g., GPUs and/or CPUs) which can process many threads/streams in parallel.

In some implementations, host system 720 could include hundreds of parallel processing threads that can request and process different subsets of the training data concurrently. In some implementations, at least some of the processing tasks of the ML/AI framework 750 are performed by the compute die 110 of the compute device 102 (FIG. 1) or by the processing units 512, 514 residing on the hybrid memory device 500A of FIG. 5A. In embodiments, one or more of the compute device 102 or the hybrid memory devices 500A are employed by the memory sub-system as memory devices 730A-730N.

Once a certain amount of training is complete, ML/AI framework 750 can enter an inference phase to analyze different input data. The input data can similarly be stored on memory device 730 of the same or a different memory sub-system 710. In some implementations, ML/AI framework 750 can issue requests to read the input data from memory sub-system 710 and store a copy of the input data in the host memory 722.

In some implementations, the host system 720 utilizes a set of queues to track the memory access commands issued to the memory sub-system 710 (e.g., requests to read data for ML/AI framework 750). For example, the host system 720 can include a number of submission queues, storing submission queue entries representing the memory access commands issued to the memory sub-system 710, and a number of completion queues, storing completion queue entries received from the memory sub-system 710 to indicate that the corresponding memory access commands have been executed. In some implementations, the host system 720 can maintain these queues in the host memory 722.

The host memory 722 may include one or more DRAM devices, HBM devices, and/or other types of memory devices. In some implementations, the host memory 722 includes the compute device 102 or one of the hybrid HBM/NVM memory devices 500A and/or 500B of FIGS. 5A-5B.

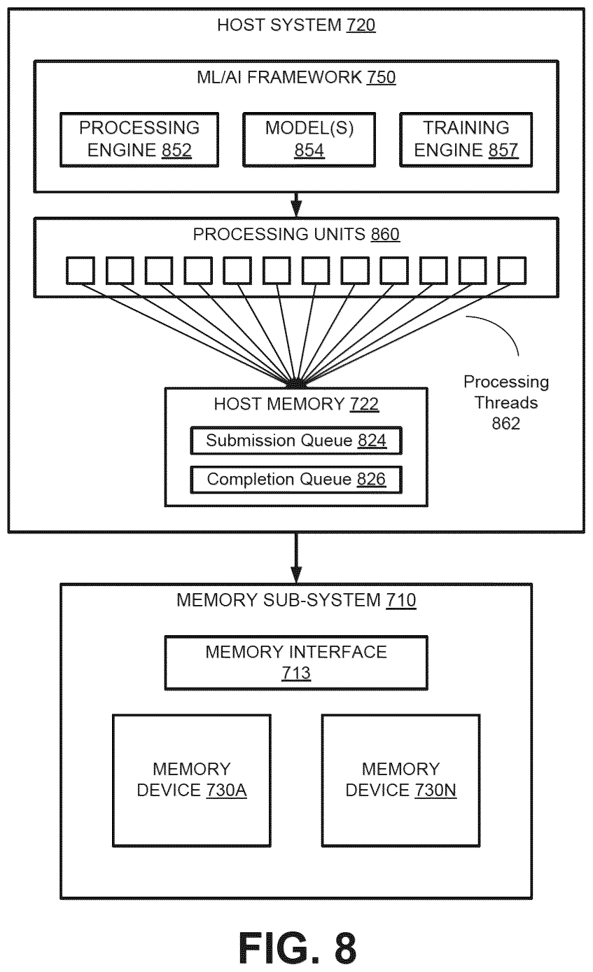

FIG. 8 is a block diagram illustrating a system for performing AI model inference operations using memory devices and/or host systems implemented in accordance with aspects of the present disclosure. As illustrated, host system 720 includes ML/AI framework 750 which can be executed by a number of processing threads 862. Host system 720 further includes host memory 722, including submission queues 824 and completion queues 246. In some implementations, ML/AI framework 750 includes a processing engine 852, one or more machine learning models 854, and a training engine 856, among other components, which can be used to perform any automated task (e.g., classify or categorize documents or images). Depending on the implementation one or more components that make up ML/AI framework 750 can be distributed across multiple different computing devices (e.g., host computers, servers, etc.). In some implementations, processing engine 852 may use a set of trained machine learning models 854 that are trained and used to perform any number of automated operations. The processing engine 852 may also preprocess any received input data prior to using the data for training of the set of machine learning models 854 and/or applying the set of trained machine learning models 854 to the input data. Based on the output of the set of trained machine learning models 854, the processing engine 852 may obtain, for example, a classification and/or category of the input data, as well an assessment of the classification.

In some implementations, at least some of the processing tasks of the ML/AI framework 750 are performed by the compute die 110 residing on the compute device 102 of FIG. 1 or by processing units 512, 514 residing on the compute die 510 of a hybrid memory device 500A of FIG. 5A. In embodiments, the compute device 102A or one or more hybrid memory devices 500A are employed by the memory sub-system as memory devices 730A-630N.

The set of machine learning models 874 may refer to model artifacts that are created by the training engine 856 using training data that includes training inputs and corresponding target outputs (i.e., correct answers for respective training inputs). During training, patterns in the training data that map the training input to the target output (i.e., the answer to be predicted) can be found, and are subsequently used by the machine learning models 854 for future predictions. Depending on the implementation, the set of machine learning models 854 may be composed of, for example, a single level of linear or non-linear operations (e.g., a support vector machine [SVM]) or may be a deep network, (i.e., a machine learning model that is composed of multiple levels of non-linear operations). Examples of deep networks are neural networks including convolutional neural networks, recurrent neural networks with one or more hidden layers, and fully connected neural networks.

Thus, in order to train and utilize the one or more machine learning models 854, ML/AI framework 750 can issue requests to read training data and input data, which may be stored on memory device 730 of memory sub-system 710, and process the data accordingly. In some implementations, these memory access requests are sent by the parallel processing threads 862 being executed by respective processing units 860. The processing units 860 can include a number of general-purpose processing devices such as microprocessors, central processing units (CPUs), or the like, or more specialized processing devices, such as graphics processing units (GPUs), which may be optimized for performing high-speed sequential processing operations. Thus, at least some of the processing units 860 may be the compute device 102 of FIG. 1.

Depending on the implementation there can be any number of processing units 860 (e.g., tens or hundreds), each executing a respective one or more of the processing threads 862. Each processing thread 862 represents a series of sequential operations directed to memory sub-system 710 (e.g., read requests for separate segments of an element of training or input data stored at memory sub-system 710). Due to the large relative size of the training data or input data, each element may be broken up into separate segments of a smaller fixed size and stored at sequential memory addresses in memory sub-system 710. Thus, in order to read the entire element of data, a sequence of multiple read requests can be issued to obtain all of the separate segments. Each processing thread 862 can include a series of read requests to read the segments of a different element of data from memory sub-system 710. Upon the read requests from each processing thread 862 being generated, the requests can be stored as entries in one of submission queues 824, from which they can be issued to memory sub-system 710. Received responses to the requests from memory sub-system 710 can be stored as entries in one of completion queues 846, retrieved by processing threads 862 and provided to ML/AI framework 750 for execution in either a training phase or an inference phase.

FIG. 9 illustrates an example machine of a computer system 900 within which a set of instructions, for causing the machine to perform any one or more of the methodologies discussed herein, can be executed. In some implementations, the computer system 900 can correspond to a host system (e.g., the host system 720 of FIG. 7) that includes, is coupled to, or utilizes a memory sub-system (e.g., the memory sub-system 710 of FIG. 7) or can be used to perform the operations of a controller (e.g., to execute an operating system to perform operations corresponding to the memory interface 713 or memory sub-system controller 718 of FIG. 7). In alternative implementations, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a data storage system 918, which communicate with each other via a bus 930.

Processing device 902 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 can also be one or more special-purpose processing devices such as an application specific integrated circuit (ASIC), a field programmable gate array (FPGA), a digital signal processor (DSP), network processor, or the like. The processing device 902 is configured to execute instructions 928 for performing the operations and steps discussed herein. The computer system 900 can further include a network interface device 908 to communicate over the network 920.

The data storage system 918 can include a machine-readable storage medium 924 (also known as non-transitory computer-readable storage medium) on which is stored one or more sets of instructions 928 (executable instructions) or software embodying any one or more of the methodologies or functions described herein. The instructions 928 can also reside, completely or at least partially, within the main memory 904 and/or within the processing device 902 during execution thereof by the computer system 900, the main memory 904 and the processing device 902 also constituting machine-readable storage media. The machine-readable storage medium 924, data storage system 918, and/or main memory 904 can correspond to the memory sub-system 710 of FIG. 7. In some implementations, the data storage system 918 may include the compute device 102 or one or more hybrid HBM/NVM memory devices 500A and/or 500B of FIGS. 5A-5B.

In some implementations, the instructions 928 include instructions to implement functionality corresponding to the memory interface 713 of FIG. 7). While the machine-readable storage medium 924 is shown in an example implementation to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A compute device comprising:
a compute die disposed on a package substrate;
a on-chip cache disposed on the package substrate and coupled to the compute die, wherein the on-chip cache comprises one or more volatile memory dies and one or more non-volatile memory dies; and
a memory controller, disposed on the package substrate, and coupled between the compute die and the on-chip cache, wherein the memory controller is configured to perform operations comprising:
separating read commands, received from the compute die, according to a plurality of processing threads executed by the compute die;
predicting, by a first prediction engine for a first processing thread, of the plurality of processing threads, a first data access pattern associated with a first read command received from the first processing thread;
determining, by a first performance monitor associated with the first prediction engine, a first statistical value corresponding to a likelihood that the first prediction engine successfully predicted the first data access pattern; and
responsive to the first statistical value satisfying a threshold value, forwarding, by the first performance monitor, a prefetch command consistent with the first data access pattern to a prefetch command manager for handling.

2. The compute device of claim 1, wherein at least one of:
the compute die comprises a plurality of processing cores, each executing one of the plurality of processing threads; or
the separating the read commands comprises detecting a thread identifier associated with each read command.

3. The compute device of claim 1, wherein the separating the read commands comprises at least one of:
determining that logical addresses or physical addresses of the read commands have spatial locality; or
determining that accesses of data at the physical addresses have temporal locality.

4. The compute device of claim 1, wherein the operations further comprise:
generating, by the first prediction engine, the prefetch command based on predicting the first data access pattern, wherein the forwarding the prefetch command is from the first prediction engine to the prefetch command manager; and
responsive to the first statistical value not satisfying a threshold value, trashing the prefetch command.

5. The compute device of claim 1, wherein the predicting the first data access pattern is based on at least one of:
changes in data addresses between sequentially received read commands;
changes in access times between the sequentially received read commands;
statistical calculations comprising at least one of a mean, a median, a probabilistic model, or a combination thereof in the changes in data addresses or the changes in access times;
application of weights to the statistical calculations based on recency of data used for determining the statistical calculations; or
detecting patterns using a pattern recognition algorithm.

6. The compute device of claim 1, wherein the determining the first statistical value is based on at least one of:
determining historical successful hit rates by the first prediction engine; or
determining a percentage of previous prefetch commands, generated by the first prediction engine, was for data ultimately used by the compute die.

7. The compute device of claim 1, wherein the operations further comprise:
predicting, by a second prediction engine for a second processing thread, of the plurality of processing threads, a second data access pattern associated with a second read command received from the second processing thread;
determining, by a second performance monitor associated with the second prediction engine, a second statistical value associated with a likelihood of successfully predicting the second data access pattern; and
responsive to the second statistical value satisfying the threshold value, forwarding, by the second performance monitor, a second prefetch command consistent with the second data access pattern to the prefetch command manager for handling.

8. The compute device of claim 1, wherein the operations further comprise:
scheduling, by the prefetch command manager, one or more prefetch commands with one or more host read commands and one or more non-volatile memory management commands; and
giving priority, when performing the scheduling, to command execution in an order comprising first to the one or more host commands, second to the one or more prefetch commands, and last to the one or more non-volatile memory management commands.

9. The compute device of claim 1, wherein the prefetch command comprises a physical address associated with a data item expected next in the first data access pattern, and wherein the operations further comprise:
in response to determining that the physical address is a hit at the one or more volatile memory dies:
retrieving, by a prefetch cache manager, the data item from the one or more volatile memory dies; and
transmitting the data item to the compute die;
in response to determining that the physical address is a miss at the one or more volatile memory dies:
causing, by the prefetch cache manager, the data item to be read out of the non-volatile memory die and stored in a location in the one or more volatile memory dies; and
transmitting the data item to the compute die; and
balancing data-storing workloads across the one or more volatile memory dies and the one or more non-volatile memory dies.

10. The compute device of claim 1, further comprising:
a logic die, disposed on the package substrate, that includes the memory controller;
an interposer interconnecting the compute die and logic die; and
an interconnect coupled to a off-chip cache that is located off of the package substrate.

11. A method comprising:
separating read commands, received from a compute die of a compute device, according to a plurality of processing threads executed by the compute die;
predicting, by a first prediction engine for a first processing thread, of the plurality of processing threads, a first data access pattern associated with a first read command received from the first processing thread, wherein the first data access pattern is in relation to a on-chip cache comprising one or more volatile memory dies and one or more non-volatile memory dies;
determining, by a first performance monitor associated with the first prediction engine, a first statistical value corresponding to a likelihood that the first prediction engine successfully predicted the first data access pattern; and
responsive to the first statistical value satisfying a threshold value, forwarding, by the first performance monitor, a prefetch command consistent with the first data access pattern to a prefetch command manager for handling.

12. The method of claim 11, wherein the separating the read commands comprises at least one of:
detecting a thread identifier associated with each read command;
determining that logical addresses or physical addresses of the read commands have spatial locality; or
determining that accesses of data at the physical addresses have temporal locality.

13. The method of claim 11, further comprising:
generating, by the first prediction engine, the prefetch command based on predicting the first data access pattern, wherein the forwarding the prefetch command is from the first prediction engine to the prefetch command manager; and
responsive to the first statistical value not satisfying a threshold value, trashing the prefetch command.

14. The method of claim 11, wherein the predicting the first data access pattern is based on at least one of:
changes in data addresses between sequentially received read commands;
changes in access times between the sequentially received read commands;
statistical calculations comprising at least one of a mean, a median, a probabilistic model, or a combination thereof in the changes in data addresses or the changes in access times;
application of weights to the statistical calculations based on recency of data used for determining the statistical calculations; or
detecting patterns using a pattern recognition algorithm.

15. The method of claim 11, wherein the determining the first statistical value is based on at least one of:
determining historical successful hit rates by the first prediction engine; or
determining a percentage of previous prefetch commands, generated by the first prediction engine, was for data ultimately used by the compute die.

16. The method of claim 11, further comprising:
predicting, by a second prediction engine for a second processing thread, of the plurality of processing threads, a second data access pattern associated with a second read command received from the second processing thread;
determining, by a second performance monitor associated with the second prediction engine, a second statistical value associated with a likelihood of successfully predicting the second data access pattern; and
responsive to the second statistical value satisfying the threshold value, forwarding, by the second performance monitor, a second prefetch command consistent with the second data access pattern to the prefetch command manager for handling.

17. The method of claim 11, further comprising:
scheduling, by the prefetch command manager, one or more prefetch commands with one or more host read commands and one or more non-volatile memory management commands; and
giving priority, when performing the scheduling, to command execution in an order comprising first to the one or more host commands, second to the one or more prefetch commands, and last to the one or more non-volatile memory management commands.

18. The method of claim 11, wherein the prefetch command comprises a physical address associated with a data item expected next in the first data access pattern, the method further comprising:
in response to determining that the physical address is a hit at the one or more volatile memory dies:
retrieving, by a prefetch cache manager, the data item from the one or more volatile memory dies; and
transmitting the data item to the compute die;
in response to determining that the physical address is a miss at the one or more volatile memory dies:
causing, by the prefetch cache manager, the data item to be read out of the non-volatile memory die and stored in a location in the one or more volatile memory dies; and
transmitting the data item to the compute die; and
balancing data-storing workloads across the one or more volatile memory dies and the one or more non-volatile memory dies.

19. A non-transitory computer-readable storage medium comprising executable instructions that, when executed by a memory controller of a compute device with a on-chip cache comprising one or more volatile memory dies and one or more non-volatile memory dies, cause the memory controller to perform operations comprising:
separating read commands, received from a compute die of a compute device, according to a plurality of processing threads executed by the compute die;
predicting, by a first prediction engine for a first processing thread, of the plurality of processing threads, a first data access pattern associated with a first read command received from the first processing thread, wherein the first data access pattern is in relation to a on-chip cache comprising one or more volatile memory dies and one or more non-volatile memory dies;
determining, by a first performance monitor associated with the first prediction engine, a first statistical value corresponding to a likelihood that the first prediction engine successfully predicted the first data access pattern; and
responsive to the first statistical value satisfying a threshold value, forwarding, by the first performance monitor, a prefetch command consistent with the first data access pattern to a prefetch command manager for handling.

20. The non-transitory computer-readable storage medium of claim 19, wherein the operations further comprise:
generating, by the first prediction engine, the prefetch command based on predicting the first data access pattern, wherein the forwarding the prefetch command is from the first prediction engine to the prefetch command manager; and
responsive to the first statistical value not satisfying a threshold value, trashing the prefetch command.
